(19) United States
(12) Patent Application Publication
(10) Pub. No.: US 2002/0196264 A1
(43) Pub. Date: Dec. 26, 2002

(54) Image compensation methods and apparatus using corrections zones

(75) Inventor: Howard V. Goetz, Tigard, OR (US)

Correspondence Address: KLARQUIST SPARKMAN, LLP, One World Trade Center,Suite 1600, 121 S.W. Salmon Street, Portland, OR, 97204, US

(73) Assignee: Sarif, Inc.

(21) Appl. No.: 10/058,814

(22) Filed: Jan. 24, 2002

Related U.S. Application Data
(60) Provisional application No. 60/264,271, filed on Jan. 25, 2001.

(51) Int. Cl. G09G 5/00

(52) U.S. Cl. 345/611

(57) ABSTRACT

Image defects are compensated by determining correction values based on an array of predetermined correction values based on display measurements. A correction value for a selected pixel is obtained by horizontal and vertical interpolation using the predetermined correction values. The computed correction values correspond to gain or offset corrections that are applied to input image values by multiplication or addition, respectively. Interpolation is based on predetermined correction values associated with a zone or subzones of a zone, or on an rate of change of an interpolation increment per row or per column.

### RELATED APPLICATIONS

This application claims the benefit of U.S. Provisional Patent Application 60/264,271, filed Jan. 25, 2001, which is incorporated herein by reference.

### FIELD OF THE INVENTION

The invention pertains to methods and apparatus for image display.

### BACKGROUND

A variety of projection displays and so-called flat panel displays have been developed based on liquid crystal display (LCD) panels. Image information is generally provided to these panels by applying appropriate voltages to a series of row and column electrodes on the LCD panel. The intersections of the row and column electrodes define picture elements (pixels) having optical properties that depend on voltages applied to the row and column electrodes. Some LCD panels also include an array of thin film transistors (TFTs), and one or more TFTs can be associated with each pixel to permit the voltages applied to each pixel to be controlled more independently of the voltages applied to other pixels.

Some displays based on TFI LCD panels are provided with shading correction circuitry that compensates for some LCD panel non-uniformities or deficiencies in other display system components such as the display optical system. Typical non-uniformities result from LCD cell-gap variations and imperfections in the optical projection system. Non-uniformities can be particularly noticeable when projecting shades of gray because slight imbalances in projected colors produce grays that appear colored or tinted. In many cases, the appearance of projected pixels varies gradually from region to region on the LCD. Because of the gradual change in appearance, display quality can be improved by measuring the projected optical transfer function of LCD panels at selected points, and, based on these measurements, determining correction values for corresponding regions of the LCD panels. These correction values can be supplied to LCD panel drive electronics to correct or compensate for non-uniformities.

Special-purpose integrated circuits can be used to provide such display correction, and correction values can be stored in a non-volatile memory in the display system. In one prior art projector, a SONY CXD3503R application specific integrated circuit (ASIC) is provided for shading correction. The SONY ASIC uses correction values that are stored in an internal correction table memory for a matrix of 16 horizontal (H) by 13 vertical (V) points for each of the 3 LCD panels used to produce color images. This ASIC includes internal logic that interpolates vertically between these points to determine correction values and produces 3 analog outputs (one per LCD panel) that can be connected to brightness inputs (also known as amplifier bias inputs) of a display processing circuit such as a SONY CXA2111 E LCD display processor. These analog outputs provide analog voltages that vary as the display is scanned based on the stored correction values. Voltages applied to amplifier bias inputs of the display processor cause variable offsets to be added to the analog video input values. Adding a positive offset causes an associated pixel to appear slightly more white and reduces the darkness of full black. Similarly, adding a negative offset causes a displayed pixel to appear slightly more black and reduces the brightness of full white.

While such prior art systems permit improved display appearance, such systems exhibit numerous deficiencies. For example, the correction values associated with pixels in a single row are constant over zone that is typically 50 or more pixels wide and then change abruptly for pixels in the next zone in the same row. While analog filtering can be applied to smooth transitions at zone edges, visible discontinuities such as brightness changes or color changes between adjacent horizontal zones remain. In addition, such prior art systems only apply a positive or negative offset to image data values, corresponding to adding or subtracting a fixed amount of light to the associated pixels. Unfortunately, real sources of the display variations that make correction necessary are generally not well corrected in this manner.

Accordingly, improved display methods and apparatus are needed.

### SUMMARY

Methods and apparatus are provided that correct, compensate, or otherwise reduce visible brightness variations and other image defects in displays. In some examples, image defects are corrected based on gain values or offset values, or both. As a specific example of an image defect, a central region of a projected image typically appears brighter than peripheral portions because of non-uniform illumination produced by a projection optical system. Such image non-uniformity can be compensated or corrected by applying pixel dependent gain-based correction values. Some image defects such a light leakage around an LCD can be associated with image data offsets and correction systems can be configured to provide both gain-based and offset-based corrections. Such corrections can be configured so that pixel-to-pixel correction value variations appear “smooth” or otherwise visually acceptable, and do not appear as additional image defects.

Display systems based on the so-called “line scan, sample and hold” architecture do not have amplifier bias inputs because a data ramp voltage that defines the pixel voltages is applied to all columns. Typically, line scan sample and hold systems include a sample and hold (S/H) capacitor corresponding to each column of an LCD panel and pixel dependent voltages are applied to these capacitors. The S/H capacitor voltages and a time-varying ramp voltage are applied to inputs of corresponding comparators so that the comparator outputs transition from one level to another at times dependent on the pixel data. The comparator outputs are typically applied to a column control element, such as a column FET that controls the application of the data ramp voltage to the column. As a result, the data ramp voltage is applied to pixels in different columns at times dependent on the pixel data, and the data ramp voltage is configured to produce a desired pixel voltage to produce the image. In display systems based on this architecture, digital image data can be directly modified to produce display corrections.

Display processors are provided that include an image signal input configured to receive an input image value associated with at least one display pixel. An interpolator is configured to determine a correction value associated with the pixel based on horizontal interpolation and/or vertical interpolation using predetermined correction values, and a data combiner is configured to combine the input image value with the correction value to produce a corrected image value. According to representative embodiments, the data combiner is configured to add (or subtract) the correction value to the input image value to produce the corrected image value. In other representative embodiments, the data combiner is configured to produce the corrected image value based on a product of the correction value and the input image value. According to additional examples, the data combiner is configured to produce the corrected image value with an addition, subtraction, multiplication, or division operation using the correction value. In additional examples, the display processor includes a memory configured to store the predetermined correction values.

Image correctors include a memory configured to store predetermined correction values and a processor configured to compute correction values associated with display pixels based upon horizontal and vertical locations of the pixels in an image. According to representative embodiments, the processor is configured to compute at least one correction value based on horizontal interpolation or vertical interpolation between predetermined correction values. In additional examples, image correctors include a multiplier configured to multiply input image values by associated correction values to produce corrected image values.

Display systems include a memory configured to store predetermined correction values associated with a set of display locations, and a correction system configured to receive input image values and produce corrected image values based on horizontal interpolation, vertical interpolation, or both horizontal and vertical interpolation with the set of predetermined correction values. One or more display panels is configured to receive the corrected image values. According to representative embodiments, the predetermined correction values are associated with display zones, and the correction system is configured to interpolate in first subzones and second subzones of the display zones. In further illustrative embodiments, the horizontal increment is adjusted based on an associated incremental change of horizontal increment per row. In other embodiments, a vertical increment is adjusted based on an associated incremental change of vertical increment per column. In other examples, the correction values are applied to the input image values as offsets or as gains.

Display interpolators include an input configured to receive a set of predetermined correction values and an adder configured to apply a horizontal increment to at least one of the predetermined correction values to produce an output correction value. According to other examples, the adder is configured to adjust the horizontal increment based on a change of horizontal increment per row determined based on the predetermined correction values. In other representative embodiments, a second adder applies a vertical increment to at least one of the predetermined correction values to produce the output correction value and a third adder is configured to adjust the horizontal increment based on a change of horizontal increment per row determined with the predetermined correction values.

Methods for correcting image values include storing predetermined correction values associated with a plurality of pixels. At least one correction value for a selected pixel is obtained by horizontal interpolation based on the predetermined correction values, and the correction value is applied to an image value associated with the selected pixel. According to representative examples, the correction value is applied to the image value as a gain or as an offset. According to additional examples, a correction gain value and a correction offset value are determined. In additional examples, at least one correction value for the selected pixel is obtained by vertical interpolation.

Image correction methods include dividing an image into zones and establishing predetermined correction values for the zones. A correction value associated with a pixel is obtained by horizontal interpolation within a zone and the correction value is applied to an image value associated with the pixel. According to other embodiments, the correction value is obtained by a combination of horizontal and vertical interpolation.

Methods for correcting image defects in a display include storing predetermined correction values and computing a correction value by interpolation based on a horizontal and vertical location of a pixel in an image using the predetermined correction values. The computed correction value is applied to an image value associated with the pixel.

Methods for correcting image defects in a display include storing predetermined correction values associated with a set of display pixels and determining a correction value associated with a pixel by applying horizontal and vertical correction value increments to at least one of the predetermined correction values. An input image value associated with the pixel is received and the correction value is applied to the input image value. According to representative examples, the correction value is applied to the input correction value as a gain, an offset, or as a gain and an offset.

These and other features of the invention are described below with reference to the accompanying drawings.

### BRIEF DESCRIPTION OF THE DRAWINGS

FIG. 1 is a block diagram of a correction system that provides corrected image values to display panels configured to receive red, blue, and green image values.

FIG. 2 is a block diagram of a data merge block that combines offset-based correction values with input image values.

FIG. 3 is a block diagram of a data merge block that combines gain-based correction values with input image values.

FIG. 4 is a block diagram of a data merge block configured to combine offset-based correction values and gain-based correction values with input image values.

FIG. 5 is a schematic diagram illustrating a division of a display region into zones associated with correction values.

FIG. 6 is a diagram illustrating division of a zone into subzones for triangular interpolation.

FIG. 7 is a schematic block diagram of a triangular linear interpolator.

FIG. 8 is a schematic block diagram of a second derivative interpolator.

FIG. 9 is a schematic block diagram of a zone decoder/sequencer.

FIG. 10 is a schematic block diagram of a color display system that produces images using interpolated correction values.

### DETAILED DESCRIPTION

Example embodiments of display methods and apparatus are described in which offset-based correction, gain-based correction, or a combination of offset-based and gain-based correction are provided. A correction system according to a first representative embodiment provides offset-based correction in which correction values are added to or subtracted from input image values. A field-programmable gate array (FPGA) is configured to generate offset-based correction values by interpolating between a series of predetermined correction values stored in a memory. In a specific example, correction values are derived from predetermined correction values obtained by display measurements associated with a matrix of 16 horizontal by 13 vertical locations in an image area. A corrected image value L′ for a selected pixel can be represented as L′=L+b, wherein L is a corresponding image data value, and b is an offset correction value obtained by interpolation based on the predetermined correction values. The offset correction value b can be either positive or negative.

Correction systems and methods according to a second example embodiment provide gain-based correction. In such systems and methods, image values are processed based on variable gain correction values that can be less than, equal to, or greater than one. In a specific embodiment, arithmetic logic implemented in an FPGA generates gain correction values by interpolating between a series of predetermined correction values stored in memory. A corrected image value L′ for a selected pixel can be represented as L′=a*L, wherein a is an interpolated gain correction value.

Correction systems and methods according to a third example embodiment provide gain-based and offset-based correction. In a specific example, arithmetic logic defined in an FPGA is used to generate interpolated correction values for both gain and offset based on an array of predetermined correction values. A corrected image value L′ for a selected pixel can be represented as L′=a*L+b, wherein a and b are interpolated gain and offset correction values, respectively.

Gain-based plus offset-based correction systems and methods can generally provide superior images to those produced by systems and methods based on offset or gain alone. However, systems that provide both gain and offset corrections can be more difficult and more costly to implement, especially in correction of real-time video data. Therefore, a choice of a particular correction system is generally based on a desired display performance, complexity, and cost.

Specific embodiments are described below with reference to a XILINX SPARTAN 2 FPGA, but in other representative embodiments, a digital ASIC, other gate array, other hardware, or software that includes instructions for execution on a computer processor can be used. Some devices are referred to as adders or adder/subtractors for convenience, but as used herein adders are configured to perform both addition and subtraction.

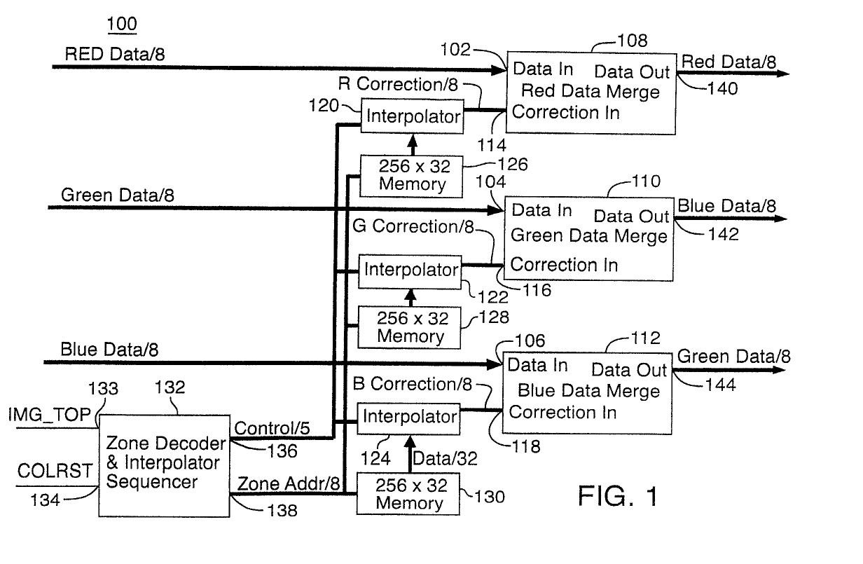

FIG. 1 is a partial schematic of a correction system 100 based on a field-programmable gate array (FPGA) that can be configured to provide offset-based correction or gain-based correction. Using additional interpolators and memories, both offset and gain-based correction can be provided. Additional interpolators and Referring to FIG. 1, red (R), green (G), and blue (B) image data are received at inputs 102, 104, 106 of data merge blocks 108, 110, 112, respectively. The inputs 102, 104, 106 are configured to receive 8-bit image data shown in FIG. 1 as Red Data /8, Green Data /8, and Blue Data /8, respectively, but in other examples, the inputs can be configured to receive image data having more or fewer bits. The data merge blocks 108, 110, 112 are configured to receive 8-bit correction data at respective correction inputs 114, 116, 118 and to process respective image data with the correction data. Typically, the data merge blocks 108, 110, 112 are configured to combine the image data associated with respective colors with associated 8-bit correction values. In some examples, the data merge blocks 108, 110, 112 are configured to correct image data for one, two, or three image colors. Correction values are provided to the data merge blocks 108, 110, 112 by corresponding interpolators 120, 122, 124 that are configured to receive 32-bit data words (Data /32) from respective memory blocks 126, 128, 130. The memory blocks 126, 128, 130 are configured to store predetermined correction parameters, typically based on display measurements at a series of image locations. Memory addresses and interpolator control are provided by a zone decoder/interpolator sequencer (“decoder/sequencer”) 132 based on a top-of-image signal (IMG_TOP) provided to a control input 133. The IMG_TOP signal can be derived from, for example, a vertical synchronization pulse obtained from an applied video signal. A column reset signal (COLRST) is also provided to a control input 134 and can be derived from, for example, a horizontal synchronization pulse. The IMG_TOP and COLRST signals permit identification of a row and column location of a selected pixel so that appropriate correction values can be selected. FIG. 1 does not show control registers, interface components, buffers, and other components that are configured to control loading of correction data into the memory blocks 126, 128, 130. In addition, the example of FIG. 1 is described with reference to specific numbers of bits for various signals, but in other examples the numbers of bits associated with various signals can be larger or smaller.

As shown in FIG. 1, the correction system 100 includes an interpolator and a memory block for red, green, and blue color components. Alternatively, correction systems can include 2 interpolators and 2 memory blocks for each color component, one for gain-based corrections and one for offset-based corrections. In such correction systems, data merge blocks can include inputs for gain correction values and offset correction values from corresponding interpolators. According to other alternative embodiments, correction for only one or two color components is provided, and interpolators for only selected color components are provided.

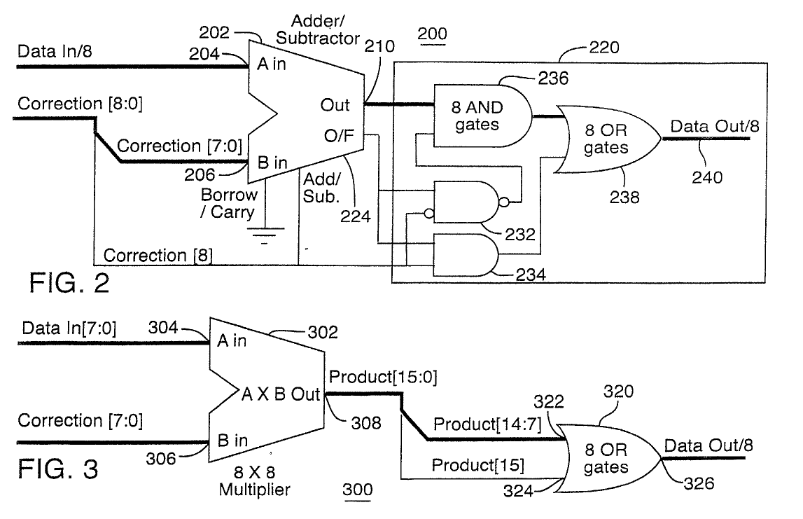

With reference to FIG. 2, a data merge block 200 configured for offset-based correction includes an adder/subtractor 202 that receives image data and correction data for a particular color component at an A-input 204 and a B-input 206, respectively. As noted previously, data merge blocks can be configured for offset-based correction, gain-based correction, or gain and offset-based correction and the data merge block 200 is configured for offset-based correction. For convenience, the data merge block 200 is simplified, and FIG. 2 does not include registers, buffers, and similar components.

The A-input 204 is configured to receive 8-bit unsigned video data (Data In/8) and deliver processed image data to a processed video output 210. The B-input 206 receives signed correction values. A most significant bit (MSB or bit 8) of a correction value is a sign bit that has a value“1” for positive correction values and “0” for negative values. In FIG. 2, signed 8-bit correction values are represented as Correction [8:0], unsigned correction values are represented as Correction[7:0], and a most significant bit is MSB is represented as Correction[8]. Based on the value of the sign bit (Correction[8]), the adder/subtractor 202 adds or subtracts a correction value to a corresponding input image value. For convenience, Table 1 lists several examples of representations of correction values as signed binary numbers and associated decimal equivalents.

TABLE 1
Example binary correction values and corresponding decimal
equivalents.

| Binary | Decimal |
|---|---|
| 10000010 | 2 |
| 10000001 | 1 |
| 10000000 | 0 |
| 00000000 | −1 |
| 00000001 | −2 |

A logic block 220 includes gates 232, 234 that are configured to receive an overflow/underflow signal from an overflow (O/F) output 224 and the sign bit Correction[8]. Arrays 236, 238 of 8 AND gates and 8 OR gates, respectively, are configured to receive processed image data from the processed video output 210 and overflow compensation signals from the gates 232, 234. The gates 232, 234, 236, 238 are configured to prevent data wraparound for data overflows or underflows. The OR-array 238 includes a corrected image data output 240 that provides corrected video data (shown in FIG. 2 as Data Out /8) that is processed with the correction values and compensated for underflow or overflow. As an example of the operation of the logic block 220, if the adder/subtractor 202 generates an overflow while the sign bit is “1” (during addition of correction data), the OR array 238 produces corrected image data that is all 1's (255) at the output 240. If the adder/subtractor 202 generates an overflow while the sign bit is “0” (during subtraction), the AND array 236 causes the corrected image data to be all 0's.

With reference to FIG. 3, a data merge block 300 configured to receive and process image values with gain-based correction values includes an 8-bit by 8-bit multiplier 302 having inputs 304, 306 for image data (Data In[7:0]) and correction values (Correction[7:0]), respectively, for a selected color component. Additional such multipliers are typically provided for correction of each color component. A product of image data and correction data (Product[15:0]) is provided to a multiplier output 308. Product bits 14-7 (Product[14:7]) are delivered to an input 322 of an OR module 320 and product bit 15 (Product[15]) is provided to an input 324. Corrected image values (Data Out /8) are produced at an OR module output 326.

In the example embodiment of FIG. 3, gain-based correction values are represented in a modified fractional binary format, wherein a correction value “decimal point” effectively follows a correction value MSB. As a result, gain correction values range from zero to just under two. For example, a gain correction value represented as an 8-bit binary number 11111111 corresponds to decimal 1.9961 (1+255/256). Table 2 lists some additional gain correction values and associated decimal values. Using this representation, correction values are effectively scaled by 128.

TABLE 2
Binary gain correction values and associated decimal equivalents.

| Binary | Decimal |
|---|---|
| 11111110 | 1.9922 |
| 11000000 | 1.5 |
| 10000000 | 1.0 |
| 01000000 | 0.5 |
| 00100000 | 0.25 |

The 8-bit wide OR gate 320 receives the product data bits 7, . . . , 14 (i.e., Product[14:7]) from the output 308 and the product data bit 15 at respective OR gate inputs 322, 324. The bits of Product[14:7] are OR'ed with bit 15 so that if bit 15 has a value “1” all output bits are assigned a value of “1” to avoid wraparound. FIG. 3 is a simplified block diagram and registers, pipelines stages, and additional components are not shown.

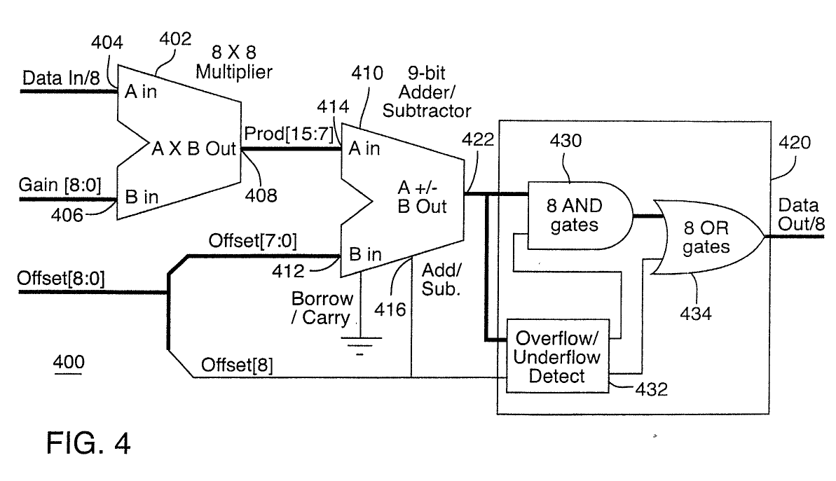

With reference to FIG. 4, a data merge block 400 configured to provide both gain and offset correction includes an 8-bit by 8-bit multiplier 402 that receives image data and gain correction values at respective inputs 404, 406 and provides a product Product[15:7] at an output 408. A 9-bit adder/subtractor 410 includes a B-input 412 configured to receive offset correction values Offset[7:0] and an A-input 414 configured to receive the Product[15:7]. An add/subtract input 416 is configured to receive a correction value sign bit (Offset[8]) to determine if a correction value is to be added or subtracted. The adder/subtractor 410 also includes a processed data output 422 that provides processed data to a logic block 420 that includes an AND gate module 430, an overflow/underflow detector 432, and an OR gate module 434. The logic block 420 receives correction value sign bits (Offset[8]) and gain/offset processed image values from the adder/subtractor 410 and is configured to detect and correct data wraparound. The output 408 of the multiplier 402 is 9-bits wide as is the input 414 of the adder/subtractor 410. This prevents loss of resolution when the output of the multiplier 402 is greater than 255 but is subsequently reduced to a value below 255 by the adder/subtractor 410.

The systems described above illustrate representative methods and apparatus configured to apply gain-based or offset-based correction values to input image data values. The correction values are typically based on predetermined correction parameters obtained by measuring display properties and establishing correction values for an array of image points. Correction values for other image points can be determined by interpolation based on stored correction values obtained from the display measurements. According to representative embodiments, interpolated offset and/or gain correction values are provided for each pixel and the correction values are configured to vary substantially continuously between the predetermined correction values. A so-called SVGA display includes about 480,000 pixels and can be corrected based on, for example, a 16 by 13 array of image points and the measurement-based correction values for these 208 points. Correction of remaining pixels is based on interpolated correction values so that for most pixels of an SVGA display or other display, interpolated correction values are used.

Interpolated correction values can be conveniently provided from a set of defined correction values using two dimensional interpolation. An interpolated correction value for a selected pixel typically depends a pixel row number and column number. Interpolation and associated memory blocks can be based on zones that are defined by display regions or pixels associated with the predetermined correction values. In representative examples described below, four correction values define a rectangular correction zone, but zones can be configured to have different shapes.

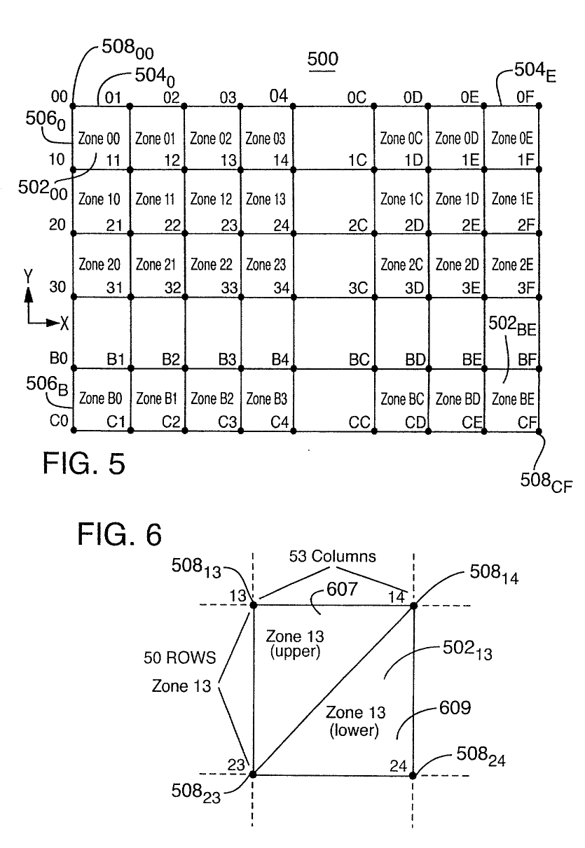

FIG. 5 is a schematic diagram illustrating a division of an image field 500 into zones 502₀₀-502_{BE} that are arranged in 15 columns 504₀-504_{E} and 12 rows 506₀-506_{B}. Points 508₀₀-508_{CF} are situated at zone corners and define a 13 row by 16 column array of correction values. Subscripts used to refer to the points 508, the zones 502, the columns 504, and the rows 506 are expressed as hexadecimal numbers (0, . . . , 9, A, . . . , F). As shown in FIG. 5, zones are identified with the same subscript as an upper leftmost point associated with the zone. Zone numbers (subscripts) can be conveniently associated with memory addresses used to store correction information for a selected zone. In an example, the zones 502 for an SVGA display are 53 pixels wide and 50 pixels high and include 795 columns of pixels so that 5 additional columns of pixels follow the pixels in the column 502_{0E}. The number of zones can be varied, and can be selected to correspond to other display resolutions such as CGA, VGA, or other resolutions.

To obtain interpolated correction values, predetermined correction values at zone boundaries are used to obtain correction values for pixels within the zones. In an example, interpolation is performed both horizontally and vertically. As shown in FIG. 5, the zones 502 are defined by points 508 that are associated with correction values that are a function of a horizontal coordinate X and a vertical coordinate Y. The correction values and associated coordinates X, Y define a surface. For simple surfaces such as planes, linear interpolation can be used to determine correction values for all points within a zone. Linear interpolation can be implemented by, for example, adding or subtracting a constant correction value for horizontal and/or vertical increments. For example, a correction value for a pixel displaced one horizontal and one vertical increment can be determined by adding corresponding horizontal and vertical correction value increments. Such correction value increments are referred to herein as X-increments and Y-increments, respectively.

Typically, correction values associated with the points that define a zone do not define a plane and simple linear interpolation can be inadequate to produce visually corrected images. Methods that produce visually corrected images based on predetermined correction values are described below. For convenience in describing these methods, associated interpolators are configured to provide triangular linear interpolation or second-x-derivative interpolation. The example interpolators receive predetermined correction values or other correction parameters from memories that are configured to store 256 32-bit words. The memories are conveniently organized as four memories of 256 8-bit words that share a common address bus but storage of the predetermined correction values can be otherwise configured. The use of the stored predetermined correction values depends on interpolation method.

Triangular Interpolation

Triangular interpolation is illustrated with reference to the zone 502₁₃. As shown in FIG. 6, the representative zone 502₁₃ is defined by points 508₁₃, 508₁₄, 508₂₃, 508₂₄ that are associated with predetermined correction values. The zone 502₁₃ is divided into triangular subzones 607, 609 that are defined by points 508₁₃, 508₁₄, 508₂₃ and 508₁₄, 508₂₃, 508₂₄, respectively, so that three predetermined correction values are associated with each subzone. The correction values and the X-and Y-coordinates of the associated points of the subzone define a plane that can be used for interpolation.

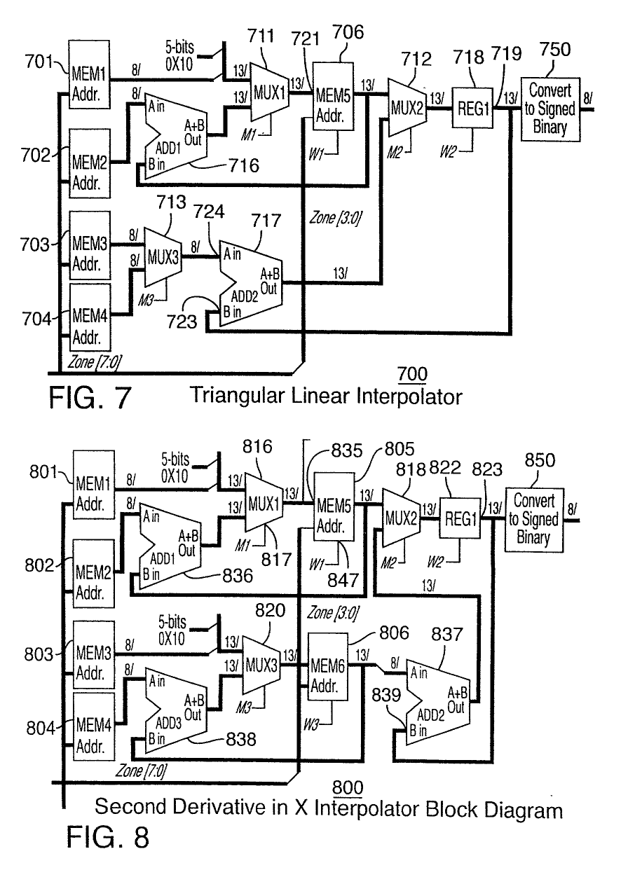

With reference to FIG. 7, an interpolator 700 based on triangular subzones includes memories 701-704 that are configured to store values associated with a selected zone. Referring to the zone 502₁₃, the following values are stored:

| | |
|---|---|
| MEM1 | predetermined correction value associated with the |
| | point 508₁₃ (upper-left corner) |
| MEM2 | a rate of change of correction value per row (i.e., |
| | vertically) |
| MEM3 | a rate of change of a correction value per column |
| | (i.e., horizontally) in the subzone 607 |
| MEM4 | a rate of change of a correction value per column |
| | in the subzone 609. |

For convenience, the memories 701-704 and values stored therein are referred to as MEM1-MEM4, respectively. The values MEM1-MEM4 correspond to a predetermined correction value of an upper left corner point, a vertical rate of change, a horizontal rate of change in a first subzone, and a horizontal rate of change of a correction value in a second subzone. These values are stored in memories 701-704. A memory 706 is configured to store, for example, 16 8-bit words for temporary storage of row starting points as values MEM5. In the example of FIG. 7, the values MEM1-MEM5 are stored as two's-complement numbers, but other storage formats can be used. The interpolator 700 includes multiplexers 711, 712, 713, adders 716, 717 and a register 718 (MUX1, MUX2, MUX3, ADD1, ADD2, ADD3, and REG1, respectively). The interpolator 700 is controlled by control signals M1, M2, M3, W1, W2, and a zone address Zone[7:0] that are provided by a zone decoder and interpolator sequencer (decoder/sequencer) that is not shown in FIG. 7.

Operation of the interpolator 700 can be described by considering corrections beginning at a first row of pixels in the zone 502₀₀. An address Zone[7:0]=0 is received from the decoder/sequencer and a predetermined correction value associated with the point 508₀₀ is read as a value MEM1 from address 00 of the memory 701. The value of MEM1 is combined with 5 lower bits 10000 (0×10) to form a 13-bit quantity that is routed by the MUX 711 to a data input 721 of the memory 706 based on a control signal M1 applied to the MUX 711. In other embodiments, different numbers of additional bits can be provided, and different total data widths can be used. For example, 7 additional bits can be used. On a subsequent clock edge, the 13-bit value is stored in location 0 of the memory 706 as a value MEM5 as controlled by the control signal W1. The stored value MEM5 is routed by the MUX 712 to the register 718 as controlled by the control signal M2. A control signal W2 controls transfer of the value MEM5 to an output 719 of the register 718 that is in communication with an binary format converter 750 and a B-input 723 of the adder 717. An A-input 724 of the adder 717 receives the value MEM3 via the MUX 713 as controlled by the signal M3. After a first value MEM5 is latched into the register 718, the signal M2 changes state so that on subsequent clock edges, the value latched into the register 718 is received from the adder 717, corresponding to incrementing the value stored in the register 718 by the value MEM3.

For corrections in the first row, the memory 703 remains selected until the end of the zone 502₀₀. At the beginning of the next horizontal zone (the zone 502₀₁), the above sequence repeats with the zone address Zone[7:0]=1 selected and the predetermined correction value associated with the point 508₀₁ stored in MEM5 at address 1. This procedure is repeated all pixels using predetermined correction values for the appropriate zone. For pixels in the first row and the last zone of the first row of zones, the storage address for the associated upper left point of the zone is 0×0E (decimal 14) of MEM5. The values stored at the various addresses of MEM5 are the predetermined correction values associated with an initial point in each zone of the current row of zones.

At the beginning of a second row of pixels, the control signal M1 changes and a value is stored in MEM5 corresponding to the previous value stored at address 0 of MEM5 combined by the adder 716 with an increment from the memory 702. Thus, the correction values associated with an initial point of the second row is approximately equal to the correction value associated with an initial point of the previous row (the point 508₀₀) combined with a vertical increment MEM2. Otherwise, processing is similar to that for the first row of pixels until near the end of the zone and a pixel is processed that is included in a lower subzone of the zone 50200. For this pixel, the MUX 713 is controlled by the control signal M3 to deliver a horizontal increment MEM4 from the memory 704 instead of the memory 703. Correction values are then determined based on interpolation in the lower subzone.

Corrections for subsequent rows are similarly processed until the bottom of the zone is reached. In each subsequent row, the point in the zone at which the MUX 713 switches from the memory 703 to the memory 704 (as controlled by the control signal M3) is closer to a left-hand edge of the selected zone, because subsequent rows of pixels cross a zone diagonal nearer this edge. Processing of rows of other zones is similar. For example, in the zone 502₁₀, the address Zone[7:0]=10 and values associated with this zone are stored.

As illustrated in FIG. 7, the memories 701-704, 706 are configured to receive two's-complement numbers, so that adders can be used for both positive or negative increments. The binary converter 750 processes the two's-complement values to produce signed binary values for delivery to data merge blocks.

The lower 5 bits (0×10) are added to allow improved interpolation when a difference between correction values associated with initial and final points of a zone is small. For example, suppose that the correction value at point 508₁₃ is 0, and that the correction value at the point 508₁₄ is 4. In this example, there are 50 pixels between these points so that the X-increment value is about 4/50 so that a correction value should change by 1 approximately every 12 pixels. Adding the lower 5-bits effectively multiplies the X-increment by 32 so that subsequent processing generates the intended interpolated values. Additional bits 10000 are used instead of 00000 to facilitate incrementing with both negative and positive values.

FIG. 7 does not include intermediate pipelining registers that can be configured to cause interpolation output to be constant for 3 clock cycles at the beginning of each zone while a value MEM1 stored in the memory 701 is moved to the register 718. As a result, the remaining portions of the zones are square, 50 pixels by 50 pixels. With square zones, identification of a zone diagonal is convenient, but other zone configurations can be used. In addition, for very large positive or negative increments, overflow or underflow can occur and interpolation circuitry can be modified to include overflow/underflow limiting/detection. Alternatively, increment values can be selected to avoid underflow/overflow. For typical correction values, overflow or underflow generally does not occur.

Second Derivative Interpolation

Interpolation can also be performed without division of a zone into triangular subzones or subzones of other shapes by modifying the value of the X-increment or the Y-increment during interpolation. An X-increment value can be incremented or decremented at the beginning of each zone in each row to produce smoothly varying corrections. Advantages of this interpolation method include a smoother interpolation result in some cases and easier handling of non-square form factor zones. Second derivative interpolation can be more complex than triangular interpolation and can require one or more additional adders and additional memory. FIG. 8 is a schematic block diagram of an interpolation system 800 based on second derivative interpolation that includes four 256-byte by 8-bit memories 801, 802, 803, 804 and two 16-byte by 8-bit memories 805, 806. In the example interpolation system 800 of FIG. 8, values MEM1-MEM6 are stored in the memories 801-806 as follows:

| | |
|---|---|
| MEM1 | upper-left corner correction value |
| MEM2 | Y-increment, i.e., rate of change of correction value per |
| | row (vertical) |
| MEM3 | X-increment, i.e., rate of change of correction value per |
| | column (horizontal) |
| MEM4 | rate of change of X-increment per row |
| MEM5 | temporary storage of row starting points |
| MEM6 | temporary storage for current x-increment |

The interpolator 800 is controlled by signals M1, M2, M3, W1, W3, W2, received from, for example, a zone decoder and interpolator sequencer (not shown in FIG. 8) that are applied to multiplexers 816, 818, 820 (MUX1 , MUX2, MUX3), memories 805, 806 (MEM5, MEM6), and a register 822 (REG1), respectively. The interpolator/sequencer also provides a zone address Zone[7:0] to address inputs (Addr) of the memories 801-806. Adders 836-838 (ADD1, ADD2, ADD3) are configured to receive correction parameters from one or more of the memories 801-806.

Operation of the interpolator 800 is described below starting with correction of the first row of the zone 502₀₀ as shown in FIG. 5. A value of the address Zone[7:0]=0 is received from the interpolator-sequencer and a correction value associated with the point 508₀₀ (the upper-left corner of the zone 502₀₀) is read as a value MEM1 from the memory 801. The value MEM1 is combined with a series of 5 lower order bits 10000 to form a 13-bit quantity that is directed to the MUX 816. A data input 835 of the memory 805 receives the signal from the MUX 816 based on the control signal M1 applied to a control input 817. Based on a clock signal such as a clock edge transition, this 13-bit quantity is stored in a location 0 of the memory 805 as enabled by the control signal W1 applied to a control input 847. The stored value MEM3 from the memory 803 is routed through the MUX 820 and stored in the memory 806 under the control of the control signals M3 and W3. The stored value MEM5 in the memory 805 is routed by the MUX 818 to the register 822 as controlled by the control signal M2. The control signal W2 applied to the register 822 causes this value to be retained in the register 822. As a result of these operations, the value MEM1 is transferred to the register 822 and an initial X-increment is stored as the value MEM6 in the memory 806.

Interpolated correction values are obtained as follows. The adder 837 receives the value stored in the register 822 at a B-input 839 and the upper 8 bits of the value MEM6 from the memory 806. After a first value MEM5 is latched from the memory 805 into the register 822, the signal M2 changes so that at subsequent clock edges, values latched into the register 822 are obtained from the adder 837 instead of directly from the memory 805. The adder 837 produces an output that is a sum of MEM1 (the correction value that is currently stored in the register 822) plus the X-increment stored as MEM6 in the memory 806. This value is then stored in the register 822 so that at a subsequent clock edge, the X-increment (the upper 8 bits of the value MEM6) is added to the first correction value to produce a second correction value. This procedure repeats for subsequent clock edges associated with additional pixels in the first row.

Correction values for a first row of pixels are obtained with the X-increment value MEM3 for the zone 502₀₀ (zone 00) stored as MEM6 until the end of the zone. At the beginning of the next horizontal zone (Zone 1), the above procedure repeats with the address Zone[7:0] of 1 instead of 0 (i.e., zone 1 is selected), and values associated with the zone 502₀₀ are stored in MEM5 and MEM6 at address 1, with values for the zone 502₀₀ remaining stored at address 0. Correction values associated with pixels of the first row are similarly obtained for the remaining zones. For the last zone, values of an initial zone correction value and the an X-increment are stored at address 0x0E (decimal 14) in the memories 805, 806 as MEM5 and MEM6. After correction values have been obtained for the first row of pixels, initial correction values associated with each zone are stored in the memory 805 and X-increment values for the zones are stored in the memory 806.

At the beginning of the second row, the sequencer/decoder causes signals M1 and M3 to change state so that the adder 836 sums a previously stored value from MEM5, address 0 with a Y-increment MEM2 from the memory 802. As a result, an initial correction value associated with the second row of pixels corresponds to the initial correction value for the first row of pixels plus a vertical increment. Similarly, the adder 838 sums a stored value MEM6, address 0 (the X-increment) with MEM4 (the rate of change of X-increment per row) to produce an X-increment that is transferred to the memory 806. Correction values for the remaining pixels of the second row are then determined in a manner similar to that for the first row. At zone boundaries, increment values are refreshed.

Correction values for additional rows are similarly determined by refreshing X-increment and Y-increment values. When correction values for all pixels in the first row of zones have been determined, correction values for pixels associated with the second row of zones are similarly determined. In the first zone of the second row of zones, the decoder/sequencer supplies the address Zone[7:0]=10, and appropriate values are stored in the memories.

As shown in FIG. 8, correction values and associated parameters are represented as two's-complement values, so that adders such as the adders 836, 837, 838 can be used to apply positive or negative increments. The interpolation system 800 includes a format converter 850 that is configured to convert two's-complement values to a signed-binary format for use by data merge blocks.

The lower 5 bits are added to improve interpolation when a difference between correction values associated with a beginning and ending points of a row of a zone is small. For example, suppose that correction values of 0, 14 are associated with points 508₁₃ and 508₁₄, are 0 and 4, respectively. The number of pixels between these points is typically about 50 so that an X-increment is about 4/50 and the correction value should change by 1 approximately every 12 pixels. The additional 5-bits effectively multiply the X-increment by 32. Different numbers of additional bits can be used, for example, 7 additional bits can be selected. In addition, data values, correction values, and other parameters can be represented with fewer than or more than the numbers of bits used in the examples. Additional bits can be supplied to other parameters, if desired.

FIG. 8 does not show intermediate registers that can be configured so that the interpolation output is constant for 3 clocks at the beginning of each zone while the value from MEM1 is moved into REG1. As a result, the zones are effectively square, 50 pixels by 50 pixels, with the extra 3 pixels per zone taken up by horizontal pipelining delay. Alternatively, additional pipelining and temporary storage can be provided so that interpolation output can vary for every point.

Zone Decoder and Interpolator Sequencer

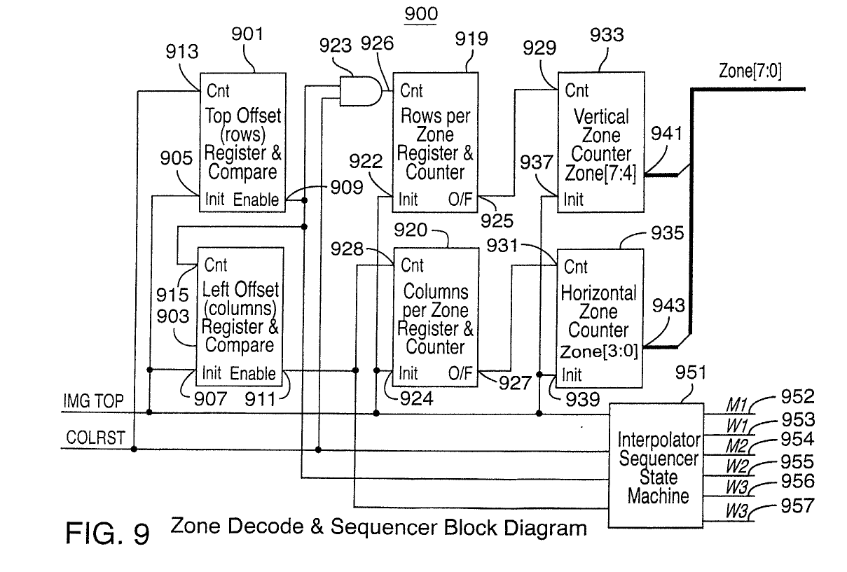

With reference to FIG. 9, a decoder/sequencer 900 includes a top offset processor 901 and a left offset processor 903 configured to receive a top of image signal (IMG_TOP) at initialize (Init) inputs 905, 907, respectively. The processors 901, 903 include respective enable outputs 909, 911 and counter (Cnt) inputs 913, 915. The counter (Cnt) input 913 of the top offset processor 901 is configured to receive a column reset (COLRST) signal and the counter (Cnt) input 915 of the left offset processor 903 is configured to receive an output from the enable output 909 of the top offset processor 901.

A rows per zone processor 919 and a columns per zone processor 920 include initialize (Init) inputs 922, 924, counter inputs (Cnt) 926, 928, and overflow outputs (O/F) 925, 927, respectively. The initialize inputs 922, 924 are configured to receive the IMG_TOP signal and the counter input 926 is in communication with a gate 923. A vertical zone counter 933 and a horizontal zone counter 935 include counter (Cnt) inputs 929, 931, initialize (Init) inputs 937, 939, and partial zone address outputs 941, 943, respectively. A state machine 951 receives the IMG_TOP and COLRST signals and provides control signals M1, W1, M2, W2, M3, W3 at outputs 952, 953, 954, 955, 956, 957, 959, respectively. For convenience, address and data buses and logic associated with writing to various programmable registers are not shown in FIG. 9.

The decoder/sequencer 900 generates zone addresses, and control signals for interpolation. The operation of the zone processor 900 is briefly described as follows. The IMG_TOP signal that is derived from a vertical synch pulse initializes the processors 901, 903 and the counters 919, 920, 933, 935. After initialization, the top offset processor 901 counts rows down to the region at which image correction values are to be determined. This region is defined by a value written to a register (not shown in FIG. 9) of the top offset processor 901. Rows are identified based on the COLRST signal that is derived from a horizontal synch signal. The top offset processor 901 is configured to enable the left offset processor 903 to identify a first column for which correction values are to be determined. This column can be defined by a value written to a left offset register (not shown in FIG. 9) or otherwise defined.

As enabled, the rows per zone counter 919 counts rows from 0 to a zone height (typically about 50 pixels), resets to zero, and repeats. The zone height is selectable based on a value stored in a register in the top processor 901 or otherwise selected. Overflow signals from the rows per zone counter 919 increment the vertical zone counter 929 so that an upper 4 bits of a zone address can be determined. The left offset processor 903 generates an output that enables the columns per zone counter 920 to count columns from an initial column of a zone to a zone width (typically about 50 pixels). The counter 920 then resets to zero so that a column count for a subsequent zone can be obtained. The zone width is register programmable, or otherwise selectable. Overflows from the counter 920 increment the horizontal zone counter 935 that generates a lower 4 bits of a zone address.

The signals IMG_TOP, COLRST, and signals from enable outputs 909, 911 are delivered to a state machine 951 that generates the signals M1, W1, M2, W3, M3, and W3 (for second derivative in X-interpolation only) at outputs 952-957, respectively.

The methods described above can be implemented in hardware as shown in, for example, FIGS. 1-9. Zone parameters such as predetermined correction values associated with the zones are communicated to a display processor as well as zone characteristics such as zone height, zone width, zone top offset, and zone left offset. Typically a display system includes a non-volatile memory configured to store an array of correction values. During system power-up, a system CPU or controller reads the stored values and establishes correction parameters for downloading to the memories used by the interpolators. The system CPU can be configured to determine the contents of the various memory tables and this determination can be similar for offset, gain, or offset plus gain correction. For systems using both gain and offset corrections, values associated with both gain and offset are typically downloaded.

Addresses in the correction data memories can be configured to directly correspond to physical position of the point at the upper left corner of each zone, as shown in FIG. 5. For example, correction data for Zone 23 can be stored at an address Ox23. Data for a point immediately to the right of this point can be stored at 0x24 and the data for a point directly below 0x23 can be stored at an address Ox33.

For triangular interpolation values stored in MEM1 are predetermined correction values. The memory MEM2 is configured to store differences between the correction data for the current pixel and for a pixel vertically below, divided by the zone height and multiplied by 32 (because of the additional 5 bits). Data stored in the memory MEM3 is the difference between the correction data for the current pixel and for the next pixel horizontally to the right, divided by the zone width and again multiplied by 32. Data in MEM4 is a difference between the correction data for the pixel vertically below the current one, and the correction data for the pixel immediately to the right, again divided by the zone width and multiplied by 32.

For second derivative interpolation, the memory MEM1 is configured to store predetermined correction values and the memory MEM2 is configured to store differences between the correction values for the current pixel and for the pixel vertically below, divided by the zone height and multiplied by 32 (because of the additional 5 bits). The memory MEM3 stores a difference between the correction data for the current pixel and for the next pixel horizontally to the right, divided by the zone width and again multiplied by 32. The memory MEM4 stores the difference between the MEM3 result for the current pixel and the MEM3 result for the next pixel vertically below, divided by the zone height and multiplied by 32. If different numbers of additional bits are selected, a multiplier other than 32 is used. For example, if 7 additional bits are used, a multiplier of 2⁷=128 is selected.

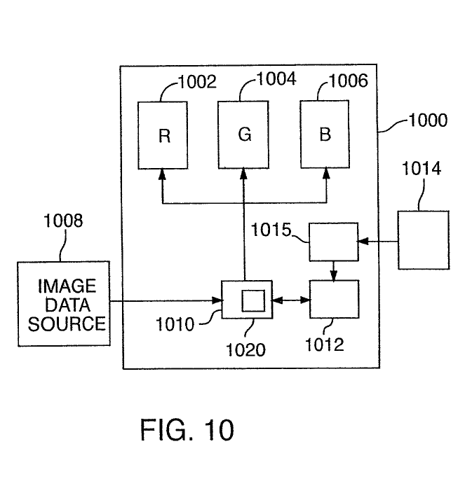

With reference to FIG. 10, a display system 1000 includes display panels 1002, 1004, 1006 configured to display red, green, and blue color components, respectively, of image data provided by an image data source 1008. The display system 1000 includes a display processor 1010 configured to receive correction values from an interpolator 1012 that provides correction values based on a set of predetermined values provided by a calibration system 1014 to a memory 1015. A decoder/sequencer 1020 provides control signals and addresses to the interpolator 1012.

Representative embodiments of the invention are described above. In alternative embodiments, zones are defined of different shapes and/or sizes. For example, the zones can be less than or more than 50 pixels wide or tall, and the number of zones can be less than or greater than 180. The zones can be arranged in fewer or more rows and columns, and the zones can be rectangular or other shape. Correction data or other data can be represented in various forms such as signed binary numbers, unsigned binary numbers, two's complement numbers, one's complement numbers, or in other representations. In addition, the bit length of data representations can be 2, 4, 8, 16, 32, 64 or other convenient length, including bit lengths that are not equal to powers of two. Correction data can be stored in ROM, EPROM, RAM, or other computer readable media. Interpolation can also be configured to produce correction values for pixels situated outside of a selected zone.

Image processing systems can include FPGAs, ASICs, discrete logic, DSP processors, or general purpose microprocessors. Triangular linear interpolation can be based on zone diagonals that extend from an upper left corner of a zone to a lower right corner of a zone, or from a lower left corner of a zone to an upper right corner. Alternatively, other zone diagonals can be used that extend to or from one or no zone corners. A zone diagonal need not divide a zone into approximately equal areas. Systems and methods based on second derivatives can be based on horizontal or vertical derivatives. Brightness variations and other image defects can be similarly corrected. The representative embodiments described above include overflow/underflow correction at particular processing steps, but such corrections can be provided in one or more adders or other hardware. Other embodiments can include variations that either eliminate or modify the offset registers (top and/or left), or use prescaling by fewer or more than 5 bits. In addition, alternative embodiments can provide interpolators configured to interpolate along only an X-axis or a Y-axis, and can be configured to use alternative register or pipeline arrangements, or that eliminate or modify the 3-pixel “flat” areas between the zones. In the examples, pixel locations are referred to using left, right, top, and bottom, but other directional references can be used.

Some LCD panels of a projection display system typically provide image data to some display panels from left-to-right and top-to-bottom while other panels receive image data from right-to-left or bottom-to-top. These directions are usually based on, for example, a number of reflectors used to deliver an image from a selected panel to a display screen, or a projector mounting configuration. Left-to-right correction is described in the above examples. Right-to-left correction can be similarly provided using an associated set of predetermined correction values or using the same correction values used in left-to-right correction. If the same correction values are used, it is convenient to decrement zone addresses, e.g., to count from 15 down to 0 instead of counting from 0 to 15 as in right-to-left correction. In addition, an upper right hand point of a zone can be used to establish an initial correction value, and zone indices can be incremented by one. Adder/subtractors can be provided instead of adders.

It will be appreciated that the representative embodiments described can be changed in arrangement and detail without departing from principles of the invention. I claim all that is encompassed by the appended claims.

I claim:

1. A display processor, comprising:
an image signal input configured to receive an input image value associated with a display pixel;
an interpolator configured to determine at least one correction value associated with the display pixel based on horizontal interpolation using predetermined correction values; and
a data combiner configured to combine the input image value with the correction value to produce a corrected image value.

2. The display processor of claim 1, wherein the data combiner is configured to sum the correction value with the input image value to produce the corrected image value.

3. The display processor of claim 1, wherein the data combiner is configured to produce the corrected image data value based on a product of the correction value and the input image value.

4. The display processor of claim 1, wherein the interpolator is configured to determine the at least one correction value based on horizontal interpolation and vertical interpolation using the predetermined correction values.

5. The display processor of claim 4, wherein the data combiner is configured to sum the correction value with the input image value to produce the corrected image value

6. The display processor of claim 4, wherein the data combiner is configured to produce the corrected image data value based on a product of the correction value and the input image value.

7. The display processor of claim 1, wherein the interpolator is configured to determined at least a first correction value and a second correction value associated with a display pixel based on horizontal interpolation using the predetermined correction values, wherein the first correction value and the second correction value correspond to a gain and an offset, respectively.

8. The display processor of claim 7, wherein the interpolator is configured to determine the first correction value and the second correction value based on horizontal interpolation and vertical interpolation using the predetermined correction values.

9. The display processor of claim 1, further comprising a memory configured to store the predetermined correction values.

10. An image corrector, comprising:
a memory configured to store predetermined correction values;
a processor configured to compute correction values associated with a display pixel based upon a horizontal and a vertical location of the pixel in an image.

11. The image corrector of claim 10, wherein the processor is configured to compute at least one correction value based on horizontal interpolation using the predetermined correction values.

12. The image corrector of claim 10, wherein the processor is configured to compute at least one correction value based on horizontal interpolation and vertical interpolation using the predetermined correction values.

13. The image corrector of claim 12, further comprising a multiplier configured to multiply an input image value by the computed correction value to produce a corrected image value.

14. A display system, comprising:
a memory configured to store predetermined correction values associated with a set of image locations;
a correction system configured to receive input image values and produce corrected image values based on horizontal interpolation with the set of predetermined correction values; and
at least one display panel configured to receive corrected image values.

15. The display system of claim 14, wherein the predetermined correction values are associated with display zones, and the correction system is configured to interpolate in first subzones and second subzones of the display zones.

16. The display system of claim 14, wherein a horizontal increment is adjusted based on an associated incremental change of horizontal increment per row.

17. The display system of claim 16, wherein the correction values are applied to the input image values as offsets.

18. The display system of claim 16, wherein the correction values are applied to the input image values as gains.

19. A display interpolator, comprising:
an input configured to receive a set of predetermined correction values; and
a horizontal increment adder configured to apply a horizontal increment to at least one of the predetermined correction values to produce an output correction value.

20. The display interpolator of claim 19, further comprising an increment adjustment adder configured to adjust the horizontal increment based on a change of horizontal increment per row determined based on the predetermined correction values.

21. The display interpolator of claim 19, further comprising a vertical increment adder configured to apply a vertical increment to at least one of the predetermined correction values.

22. The display interpolator of claim 21, further comprising an increment adjustment adder configured to adjust a vertical increment based on a change of vertical increment per column determined based on the predetermined correction values.

23. A method for correcting image values, comprising:
storing predetermined correction values associated with a plurality of pixels;
obtaining at least one correction value for a selected pixel by horizontal interpolation based on the predetermined correction values; and
applying the correction value to an image value associated with the selected pixel.

24. The method of claim 23, wherein the at least one correction value is obtained by horizontal interpolation and vertical interpolation based on the predetermined correction values.

25. The method of claim 23, wherein at least two correction values are obtained for the selected pixel, the correction values including a correction gain value and a correction offset value.

26. An image correction method, comprising:
dividing an image into zones;
establishing predetermined correction values associated with the zones;
obtaining a correction value associated with a pixel by horizontal interpolation within a zone; and
applying the correction value to an image value associated with the pixel.

27. The image correction method of claim 26, wherein the correction value associated with a pixel is obtained by horizontal interpolation and vertical interpolation within a zone.

28. A method for correcting image defects in a display, the method comprising the steps of:
storing predetermined correction values associated with a set of display pixels;
determining a correction value associated with a pixel by applying horizontal and vertical correction value increments to at least one of the predetermined correction values;
receiving an input image value associated with the pixel; and
applying the correction value to the input image value.

29. The method of claim 28, wherein the correction value is applied to the input correction value as a gain.

30. The method of claim 28, wherein the correction value is applied to the input correction value as an offset.
